(19) United States
(12) Patent Application Publication
(10) Pub. No.: US 2013/0253119 A1
(43) Pub. Date: Sep. 26, 2013

(54) HIGH STRENGTH ORGANIC/INORGANIC COMPOSITE USING PLATE-SHAPED INORGANIC PARTICLES AND METHOD FOR PREPARING SAME

(71) Applicants: Young-Hee Kim, Seoul (KR); Soo-Ryong Kim, Seoul (KR); Woo-Teck Kwon, Seoul (KR); Yoon-Joo Lee, Seoul (KR); Hyung-Mi Lim, Gunpo-si (KR); Kyoung-Mok Nam, Seoul (KR)

(72) Inventors: Young-Hee Kim, Seoul (KR); Soo-Ryong Kim, Seoul (KR); Woo-Teck Kwon, Seoul (KR); Yoon-Joo Lee, Seoul (KR); Hyung-Mi Lim, Gunpo-si (KR); Kyoung-Mok Nam, Seoul (KR)

(73) Assignee: Korea Institute of Ceramic Engineering and Technology, Seoul (KR)

(21) Appl. No.: 13/991,658

(22) PCT Filed: Dec. 6, 2011
(86) PCT No.: PCT/KR2011/009396

§ 371 Date: Jun. 5, 2013

(30) Foreign Application Priority Data
Dec. 6, 2010 (KR) 10-2010-0123755
Dec. 6, 2011 (KR) 10-2011-0129897

(51) Int. Cl. C08K 3/36; C08K 3/22; C08J 3/20

(52) U.S. Cl. CPC C08K 3/36; C08J 3/203; C08K 3/22
USPC 524/430; 524/611; 264/28; 264/331.11

(57) ABSTRACT

The present invention relates to a high strength organic/inorganic composite using plate-shaped inorganic particles and to a method for preparing the same. The organic/inorganic composite of the present invention comprises a polymer and inorganic particles uniformly arranged into a matrix structure in said polymer. A mineral bridge is formed between the inorganic particles. According to the present invention, plate-shaped inorganic particles are uniformly distributed in the polymer to improve the filling rate of inorganic particles, and a mineral bridge is formed between the inorganic particles to provide a high strength and lightweight organic/inorganic composite. The organic/inorganic composite of the present invention may be widely used in high value-added industry such as an aerospace industry, space industry, car industry, energy industry, environmental industry, defense industry and construction industry.

### TECHNICAL FIELD

The present invention relates to a high strength organic/inorganic composite using plate-shaped inorganic particles and a method of manufacturing the same, and, more particularly, to a high strength organic/inorganic composite using plate-shaped inorganic particles, wherein, in the preparation of the organic/inorganic composite comprising a polymer and inorganic particles regularly arranged in the polymer, a mineral bridge is formed between the inorganic particles charged in the polymer, thus exhibiting superior strength, and to a method of manufacturing the same.

### BACKGROUND ART

Energy saving based on lightweightness required of aviation industry, space industry and automotive industry is considered to be the important technology of the 21^{st} century, and the demand for lightweight and high strength materials in energy environmental industries, etc. is increasing.

Accordingly, thorough research into polymer nanocomposites including nanoclay with a very high aspect ratio (200˜1000) as a nanocomposite material is ongoing these days, but the nanoclay has a large number of attached layers due to the properties thereof, making it difficult to exfoliate such layers. Hence, it is difficult to attain nanocomposites in which component materials are efficiently distributed.

In the case of biomimetic nanocomposites, these are lighter by 25˜50% compared to metals having the same strength, and are receiving attention as materials able to substitute for metals as materials for parts of automobiles and airplanes. Natural structures are very complicated, making it remarkably difficult to mimic them.

Although extensive and intensive research into production of nanocomposites which mimic high strength natural materials such as pearl layers or bones has been carried out, materials having satisfactory performance have not yet been developed. For example, a lightweight nanocomposite including and a polymer and nanoclay which mimics the microstructure of an abalone shell has been reported, but, with current technology, such a composite may be manufactured only in the form of a thin film.

A hydrothermal hot pressing method is a method of manufacturing a hard sintered body at a relatively low temperature under saturated vapor pressure, and has been mainly utilized in forming solid bodies from calcium carbonate, magnesium carbonate, etc. which are difficult to sinter. However, since the 1990s, the above method has been applied to preparation of biomaterials, and U.S. Pat. No. 6,338,810 discloses a method of solidifying calcium phosphate powder such as α-tricalcium phosphate (α-TCP), tetracalcium phosphate (TeCP), etc., by applying a pressure of 100˜500 MPa at 100˜500° C. in the presence of water to form a compact body.

Also, Kazuyuki Hosoi et al. proposed a method of solidifying dicalcium phosphate dehydrate (DCPD) and calcium hydroxide under conditions of 150° C. and 40 MPa (J. Am. Ceram. Soc., 79 [10] 2771-2774, 1996). In this method, even when water is not applied from the outside, DCPD is dehydrated at high temperature, so that hydrothermal conditions are maintained in a reactor. The calcium phosphate-based materials solidified by the hydrothermal hot pressing method have been mostly studied as replacement materials for bones.

The present inventors have found that, in the case of preparing an organic/inorganic composite in which inorganic particles are regularly arranged into a matrix structure in a polymer using such a hydrothermal hot pressing method, the filling rate of inorganic particles in the polymer may be increased, and a mineral bridge may be formed between the inorganic particles charged in the polymer, thus exhibiting much higher strength compared to conventional organic/inorganic composites, which culminated in the present invention.

### DISCLOSURE

### Technical Problem

An object of the present invention is to provide a method of manufacturing a lightweight and high strength organic/inorganic composite, suitable for use in high value-added industries, including the aviation industry, space industry, automotive industry, energy industry, environmental industry, defense industry, construction industry, etc.

### Technical Solution

In order to accomplish the above object, the present invention provides a high strength organic/inorganic composite, comprising a polymer and inorganic particles uniformly arranged into a matrix structure in the polymer, wherein a mineral bridge is formed between the inorganic particles.

The high strength organic/inorganic composite preferably comprises 20˜50 wt % of the polymer and 50˜80 wt % of the inorganic particles.

The inorganic particles may be one or more plate-shaped particles selected from the group consisting of nanoclay including bentonite and montmorillonite, calcium carbonate, silica, alumina, ceria, magnesium hydroxide, zinc oxide, iron oxide and titanium oxide.

The polymer may be selected from the group consisting of, for example, polymethylmethacrylate, polyester, polyepoxy, polyimide, polyethylene, polypropylene, phenolic resins, polyamide and polycarbonate.

The high strength organic/inorganic composite may exhibit a mechanical strength of 150˜250 Mpa and a density 1.5˜3 g/cm³.

In addition, the present invention provides a method of manufacturing a high strength organic/inorganic composite, comprising distributing inorganic particles in a solvent in a vessel, performing freeze casting, and removing the solvent, thus forming a solid (Step 1); incorporating the solid into a polymer, thus preparing a mixture (Step 2); and adding a mineralizer to the mixture, and performing hot pressing (Step 3).

The inorganic particles may be one or more plate-shaped particles selected from the group consisting of nanoclay including bentonite and montmorillonite, calcium carbonate, silica, alumina and titanium oxide.

In Step 1, the inorganic particles may be distributed in the solvent selected from the group consisting of water, alcohol, acetone and dichloroethylene, and frozen at −100˜0° C. so as to be solidified.

The polymer may be selected from the group consisting of polymethylmethacrylate, polyester, polyepoxy, polyimide, polyethylene, polypropylene, phenolic resins, polyamide and polycarbonate.

In Step 3, the mineralizer is preferably added in an amount of 100˜200 parts by weight to the mixture based on the total weight of the mixture.

The mineralizer may be selected from the group consisting of sodium hydroxide, potassium hydroxide, hydrochloric acid, nitric acid, sulfuric acid, acetic acid and citric acid.

Step 3 may be performed by applying a pressure of 100˜500 N/m² at 100˜300° C.

Step 3 is preferably performed using hydrothermal hot pressing.

The hydrothermal hot pressing is preferably performed by applying a pressure of 150˜500 N/m² at 100˜200° C.

The method may further comprise removing the mineralizer from a product obtained after Step 3 and drying the product.

The high strength organic/inorganic composite obtained using the above method is configured such that the inorganic particles are uniformly distributed in the polymer, and a mineral bridge is formed between the inorganic particles.

In addition, the present invention provides a method of manufacturing a high strength organic/inorganic composite, comprising mixing plate-shaped inorganic particles with an organic binder, and performing compacting, thus forming a solid (Step 1); incorporating the solid into a polymer, thus preparing a mixture (Step 2); and adding a mineralizer to the mixture, and performing hot pressing (Step 3).

The above method enables the preparation of a high strength organic/inorganic composite comprising a polymer and inorganic particles uniformly arranged into a matrix structure in the polymer, wherein a mineral bridge is formed between the inorganic particles.

The inorganic particles may be one or more plate-shaped particles selected from the group consisting of, for example, nanoclay including bentonite and montmorillonite, calcium carbonate, silica, alumina and titanium oxide.

The organic binder may be selected from the group consisting of, for example, polyvinylalcohol (PVA), phenolic resins, starches, carboxymethylcellulose, dextrin, wax emulsions, polyethylene glycols, lignosulfonates, methylcellulose, paraffins and polyacrylates.

The polymer may be selected from the group consisting of, for example, polymethylmethacrylate, polyester, polyepoxy, polyimide, polyethylene, polypropylene, phenolic resins, polyamide and polycarbonate.

In Step 3, the mineralizer is preferably added in an amount of 100˜200 parts by weight to the mixture based on the total weight of the mixture.

The mineralizer may be selected from the group consisting of, for example, NaOH, KOH, HCl, CH₃COOH, H₂SO₄ and HNO₃.

Step 3 is preferably performed by applying a pressure of 100˜500 N/m² at 100˜300° C.

Step 3 is preferably performed using hydrothermal hot pressing.

The hydrothermal hot pressing is preferably performed by applying a pressure of 150˜500 N/m² at 100˜200° C.

The method of manufacturing the high strength organic/inorganic composite may further comprise removing the mineralizer from a product obtained after Step 3 and drying the product.

The high strength organic/inorganic composite obtained using the above method is configured such that the inorganic particles are uniformly distributed in the polymer, and a mineral bridge is formed between the inorganic particles.

### Advantageous Effects

According to the present invention, plate-shaped inorganic particles are regularly distributed in a polymer, thus increasing the filling rate of the inorganic particles, and a mineral bridge is formed between the inorganic particles to provide a lightweight and high strength organic/inorganic composite, whereby such a composite can be widely utilized in high value-added industries, including the aviation industry, space industry, automotive industry, energy industry, environmental industry, defense industry, construction industry, etc.

### DESCRIPTION OF DRAWINGS

FIG. 1 is a flowchart schematically illustrating a process of manufacturing a high strength organic/inorganic composite according to an embodiment of the present invention;

FIG. 2 is a flowchart schematically illustrating a process of manufacturing a high strength organic/inorganic composite according to another embodiment of the present invention; and

FIG. 3 is a cross-sectional view illustrating the organic/inorganic composite in which a mineral bridge is formed between inorganic particles distributed in a polymer by a hydrothermal hot pressing process in the process of manufacturing the high strength organic/inorganic composite according to the present invention.

### MODE FOR INVENTION

Hereinafter, a detailed description will be given of the present invention.

The present invention provides a high strength organic/inorganic composite comprising a polymer and inorganic particles uniformly arranged into a matrix structure in the polymer, wherein a mineral bridge is formed between the inorganic particles.

In an embodiment of the present invention, the high strength organic/inorganic composite may comprise 20˜50 wt % of the polymer and 50˜80 wt % of the inorganic particles.

The polymer may include, but is not limited to, polyethylene, polypropylene, phenolic resins, polyamide, polycarbonate, etc.

The inorganic particles may include oxide-based ceramics, such as nanoclay including bentonite and montmorillonite, calcium carbonate, silica, alumina, titanium oxide, etc., and the inorganic particles may be distributed in the form of a plate shape in the polymer.

The high strength organic/inorganic composite according to the present invention is configured such that the inorganic particles are uniformly distributed in the polymer and a mineral bridge is formed between the inorganic particles using hot pressing, thus exhibiting a high mechanical strength of 150˜250 MPa and a density of 1.5˜3 g/cm³.

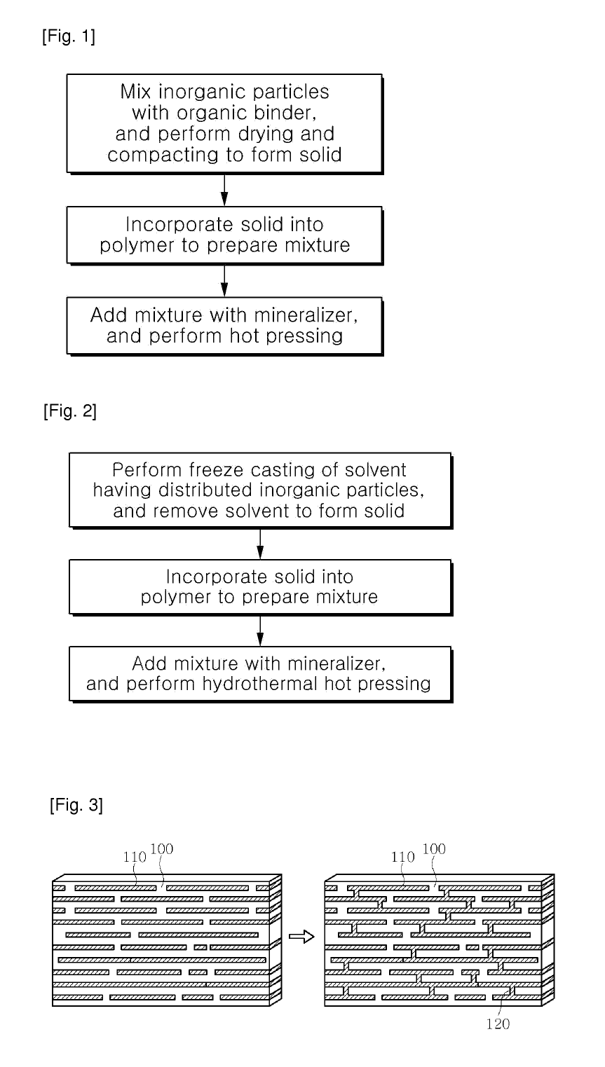

Below is a detailed description of a method of manufacturing the high strength organic/inorganic composite according to the present invention, with reference to FIG. 1.

First, plate-shaped inorganic particles are added with an organic binder, and then compacted, thus forming a solid (Step 1).

In Step 1, the plate-shaped inorganic particles are added with the organic binder, uniformly mixed, dried, compacted at a pressure of 100˜300 kN/m², and hardened, thus manufacturing a solid.

The inorganic particles may include one or more plate-shaped particles selected from the group consisting of oxide-based ceramics, for example, nanoclay including bentonite and montmorillonite, calcium carbonate, silica, alumina and titanium oxide.

The organic binder may include, for example, polyvinylalcohol (PVA), phenolic resins, starches, carboxymethylcellulose, dextrin, wax emulsions, polyethylene glycols, lignosulfonates, methylcellulose, paraffins or polyacrylates.

Subsequently, the solid obtained in Step 1 is incorporated into the polymer, thus preparing a mixture (Step 2).

The polymer may include, but is not limited to, polymethylmethacrylate, polyester, polyepoxy, polyimide, polyethylene, polypropylene, phenolic resins, polyamide, and polycarbonate.

Finally, the mixture obtained in Step 2 is added with a mineralizer, and then hot pressed (Step 3).

According to an embodiment of the present invention, in Step 3, 100˜200 parts by weight of the mineralizer is added to the mixture based on the total weight of the mixture obtained in Step 2, and then hot pressing is performed.

The mineralizer may be selected from the group consisting of NaOH, KOH, HCl, H₂SO₄ and HNO₃. When the mixture is added with the mineralizer in this way, the solubility of the inorganic particles at high temperature is increased.

Subsequently, the blend of the mixture obtained in Step 2 and the mineralizer is placed in a cell of a hot pressing device, and a hot pressing process may be performed by applying a pressure of 100˜500 kN/m² at 100˜300° C. Thus, an inorganic solid body may be produced using such a hot pressing process.

In order to further increase the strength, the blend of the mixture obtained in Step 2 and the mineralizer is placed in the cell of the hot pressing device, after which water is introduced into the cell, and a hydrothermal hot pressing process may be conducted. In the hydrothermal hot pressing process, the temperature and the pressure are preferably set to 100˜200° C. and 150˜500 kN/m², respectively. A dissolution-deposition mechanism is performed by use of the mineralizer at low temperature using such a hydrothermal hot pressing process, thus manufacturing an inorganic solid body.

As illustrated in FIG. 3, in the case where the hydrothermal hot pressing process is performed in Step 3 in a state in which the plate-shaped inorganic particles 110 are distributed in the polymer 100, the mineral bridge 120 is formed between the inorganic particles 110.

The mineralizer is removed from the product obtained in Step 3, and the product is dried, yielding a final high strength organic/inorganic composite according to the present invention.

When performing the method of manufacturing the high strength organic/inorganic composite according to the present invention, the resulting high strength organic/inorganic composite may be configured such that the inorganic particles are uniformly distributed to a matrix structure in the polymer, and the mineral bridge is formed between the inorganic particles.

In the method of manufacturing the high strength organic/inorganic composite according to the embodiment of the present invention, Step 1 for forming the solid may be conducted as in an embodiment of FIG. 2. The embodiment of FIG. 2 is described below.

First, inorganic particles are distributed in a solvent in a vessel such as a beaker, etc., and then subjected to freeze casting, after which the solvent is removed, thus forming a solid (Step 1).

In Step 1, the inorganic particles are distributed in the solvent in the vessel, for example, water, alcohol, acetone, dichloroethylene, etc., and then freeze casting is performed in such a manner that the contents of the vessel are solidified while being frozen from the lower portion of the vessel at −100˜0° C. to form a porous skeleton, and the solvent is removed using a vacuum pump, thereby obtaining the solid.

The inorganic particles may include one or more plate-shaped particles selected from the group consisting of oxide-based ceramics, for example, nanoclay including bentonite and montmorillonite, calcium carbonate, silica, alumina and titanium oxide.

Subsequently, the solid obtained in Step 1 is incorporated into a polymer, thus preparing a mixture (Step 2).

The polymer may include, but is not limited to, polymethylmethacrylate, polyester, polyepoxy, polyimide, polyethylene, polypropylene, phenolic resins, polyamide and polycarbonate.

Finally, the mixture obtained in Step 2 is added with a mineralizer, and then hot pressed (Step 3).

In an embodiment of the present invention, in Step 3, 100˜200 parts by weight of the mineralizer is added to the mixture based on the total weight of the mixture obtained in Step 2, and then hot pressing is performed.

The mineralizer may be selected from the group consisting of NaOH, KOH, HCl, H₂SO₄ and HNO₃. When the mixture is added with the mineralizer in this way, the solubility of the inorganic particles at high temperature is increased.

Subsequently, the blend of the mixture obtained in Step 2 and the mineralizer is placed in a cell of a hot pressing device, and a hot pressing process may be performed by applying a pressure of 100˜500 kN/m² at 100˜300° C. Using such a hot pressing process, an inorganic solid body may be manufactured.

In order to further increase the strength, the blend of the mixture obtained in Step 2 and the mineralizer is placed in the cell of the hot pressing device, after which water is introduced into the cell, and a hydrothermal hot pressing process may be conducted. In the hydrothermal hot pressing process, the temperature and the pressure are preferably set to 100˜200° C. and 150˜500 kN/m², respectively. A dissolution-deposition mechanism is performed by use of the mineralizer at low temperature using the hydrothermal hot pressing process, thus manufacturing the inorganic solid body.

Below, preferred examples of the present invention are described in detail.

### Example 1

30 g of plate-shaped alumina powder was efficiently distributed in 10 g of a phenolic resin, dried, compacted at a pressure of 300 kN/m², hardened at 100° C. so as to be solidified, completely deaerated using a vacuum pump, incorporated into a MMA (methyl methacryalte) solution containing 2.5% BPO (benzoyl peroxide), and hardened at 80° C., thus preparing a mixture. The mixture was added with 2 ml of a 2M NaOH solution, and placed in a cell of a hydrothermal hot pressing device, after which a pressure of 500 kN/m² was applied for 1 hr at a temperature of 200° C. The sample subjected to hydrothermal hot pressing was taken out, and immersed in distilled water at 40° C. for 24 hr, so that NaOH as the mineralizer was dissolved and removed, followed by performing drying, thereby manufacturing an organic/inorganic composite.

### Example 2

30 g of illerite as plate-shaped silica was efficiently distributed in 15 g of water in a beaker, solidified while being gradually frozen from the lower portion of the beaker, completely dewatered using a vacuum pump, and incorporated into a phenolic resin, thus preparing a mixture. The mixture was added with 2 ml of a 2M NaOH solution, and placed in a cell of a hydrothermal hot pressing device, after which a pressure of 100 kN/m² was applied for 1 hr at a temperature of 250° C. The sample subjected to hydrothermal hot pressing was taken out, and immersed in distilled water at 40° C. for 24 hr, so that NaOH as the mineralizer was dissolved and removed, followed by performing drying, thereby manufacturing an organic/inorganic composite.

### Comparative Example 1

30 g of plate-shaped alumina powder was efficiently distributed in 10 g of a phenolic resin, dried, compacted, hardened at 100° C. so as to be solidified, completely deaerated using a vacuum pump, incorporated into a MMA (methyl methacryalte) solution containing 2.5% BPO (benzoyl peroxide), and hardened at 80° C., thus preparing a mixture. The mixture was placed in a cell of a pressing device, after which a pressure of 500 kN/m² was applied for 1 hr. The pressed sample was taken out, thus manufacturing an organic/inorganic composite.

### Comparative Example 2

30 g of illerite as plate-shaped silica was efficiently distributed in 15 g of water in a beaker, solidified while being gradually frozen from the lower portion of the beaker, completely dewatered using a vacuum pump, and incorporated into a phenolic resin. The resulting product was placed in a cell of a pressing device, and then a pressure of 100 kN/m² was applied for 1 hr. The pressed sample was taken out, thus manufacturing an organic/inorganic composite.

### Text Example

### Compressive Strength Measurement Test

In order to measure mechanical strength of the organic/inorganic composites of Example 1 and Comparative Example 1, the mechanical strength of the organic/inorganic composite samples of Examples 1 and 2 and Comparative Examples 1 and 2, having a size of 25 mm×20 mm×120 mm, was measured using a universal testing machine (Model 5848, Microtester). Consequently, the organic/inorganic composites of Examples 1 and 2 according to the present invention exhibited strengths of 160 MPa and 150 MPa, respectively, but the organic/inorganic composites of Comparative Examples 1 and 2 manifested a strength of 100 MPa.

As is apparent from the above results, the organic/inorganic composite manufactured using a hot pressing process, especially a hydrothermal hot pressing process, according to the present invention, can exhibit superior mechanical strength, which is evaluated to be based on a structure in which a mineral bridge is formed between inorganic particles in the organic/inorganic composite according to the present invention by virtue of hot pressing treatment.

Although the preferred embodiments of the present invention have been disclosed for illustrative purposes, those skilled in the art will appreciate that various modifications, additions and substitutions are possible, without departing from the scope and spirit of the invention. Therefore, the embodiments of the present invention are set forth to illustrate, but are not to be construed as limiting, the present invention. It will be understood that the scope of the present invention is interpreted by the claims described below, and also that all technical ideas within the ranges equivalent thereto is included in the scope of the present invention.

1. A high strength organic/inorganic composite, comprising a polymer and inorganic particles uniformly arranged into a matrix structure in the polymer, wherein a mineral bridge is formed between the inorganic particles.

2. The high strength organic/inorganic composite of claim 1, comprising 20˜50 wt % of the polymer and 50˜80 wt % of the inorganic particles.

3. The high strength organic/inorganic composite of claim 1, wherein the inorganic particles are one or more plate-shaped particles selected from the group consisting of nanoclay including bentonite and montmorillonite, calcium carbonate, silica, alumina, ceria, magnesium hydroxide, zinc oxide, iron oxide and titanium oxide.

4. The high strength organic/inorganic composite of claim 1, wherein the polymer is selected from the group consisting of polymethylmethacrylate, polyester, polyepoxy, polyimide, polyethylene, polypropylene, phenolic resins, polyamide and polycarbonate.

5. The high strength organic/inorganic composite of claim 1, wherein the high strength organic/inorganic composite exhibits a mechanical strength of 150˜250 Mpa and a density 1.5˜3 g/cm³.

6. A method of manufacturing a high strength organic/inorganic composite, comprising:
distributing inorganic particles in a solvent in a vessel, performing freeze casting, and removing the solvent, thus forming a solid (Step 1);
incorporating the solid into a polymer, thus preparing a mixture (Step 2); and
adding a mineralizer to the mixture, and performing hot pressing (Step 3).

7. The method of claim 6, wherein the inorganic particles are one or more plate-shaped particles selected from the group consisting of nanoclay including bentonite and montmorillonite, calcium carbonate, silica, alumina and titanium oxide.

8. The method of claim 6, wherein in Step 1, the inorganic particles are distributed in the solvent selected from the group consisting of water, alcohol, acetone and dichloroethylene, and frozen at −100˜0° C. so as to be solidified.

9. The method of claim 6, wherein the polymer is selected from the group consisting of polymethylmethacrylate, polyester, polyepoxy, polyimide, polyethylene, polypropylene, phenolic resins, polyamide and polycarbonate.

10. The method of claim 6, wherein in Step 3, the mineralizer is added in an amount of 100˜200 parts by weight to the mixture based on a total weight of the mixture.

11. The method of claim 10, wherein the mineralizer is selected from the group consisting of sodium hydroxide, potassium hydroxide, hydrochloric acid, nitric acid, sulfuric acid, acetic acid and citric acid.

12. The method of claim 6, wherein Step 3 is performed by applying a pressure of 100˜500 N/m² at 100˜300° C.

13. The method of claim 12, wherein Step 3 is performed using hydrothermal hot pressing.

14. The method of claim 13, wherein the hydrothermal hot pressing is performed by applying a pressure of 150˜500 N/m² at 100˜200° C.

15. The method of claim 6, further comprising removing the mineralizer from a product obtained after Step 3 and drying the product.

16. The method of claim 6, wherein the high strength organic/inorganic composite is configured such that the inorganic particles are uniformly distributed to a matrix structure in the polymer, and a mineral bridge is formed between the inorganic particles.

17. A method of manufacturing a high strength organic/inorganic composite, comprising:
mixing inorganic particles with an organic binder, and performing drying and compacting, thus forming a solid (Step 1);
incorporating the solid into a polymer, thus preparing a mixture (Step 2); and
adding a mineralizer to the mixture, and performing hot pressing (Step 3).

18. The method of claim 17, wherein the inorganic particles are one or more plate-shaped particles selected from the group consisting of nanoclay including bentonite and montmorillonite, calcium carbonate, silica, alumina and titanium oxide.

19. The method of claim 17, wherein the organic binder is selected from the group consisting of polyvinylalcohol (PVA), phenolic resins, starches, carboxymethylcellulose, dextrin, wax emulsions, polyethylene glycols, lignosulfonates, methylcellulose, paraffins and polyacrylates.

20. The method of claim 17, wherein the polymer is selected from the group consisting of polymethylmethacrylate, polyester, polyepoxy, polyimide, polyethylene, polypropylene, phenolic resins, polyamide and polycarbonate.

21. The method of claim 17, wherein in Step 3, the mineralizer is added in an amount of 100˜200 parts by weight to the mixture based on a total weight of the mixture.

22. The method of claim 17, wherein the mineralizer is selected from the group consisting of NaOH, KOH, HCl, CH₃COOH, H₂SO₄ and HNO₃.

23. The method of claim 17, wherein Step 3 is performed by applying a pressure of 100˜500 N/m² at 100˜300° C.

24. The method of claim 17, wherein Step 3 is performed using hydrothermal hot pressing.

25. The method of claim 17, wherein the hydrothermal hot pressing is performed by applying a pressure of 150˜500 N/m² at 100˜200° C.

26. The method of claim 17, further comprising removing the mineralizer from a product obtained after Step 3 and drying the product.

27. The method of claim 17, wherein the high strength organic/inorganic composite is configured such that the inorganic particles are uniformly distributed to a matrix structure in the polymer, and a mineral bridge is formed between the inorganic particles.
